(19) United States
(12) Patent Application Publication
(10) Pub. No.: US 2023/0323550 A1
(43) Pub. Date: Oct. 12, 2023

(54) CO-GENERATION OF HIGH PURITY HYDROGEN AND HALIDE GASES BY ELECTROLYSIS

(71) Applicant: UNIVERSITY OF SOUTH CAROLINA, COLUMBIA, SC (US)

(72) Inventors: BENJAMIN MEEKINS, COLUMBIA, SC (US); SIRIVATCH SHIMPALEE, COLUMBIA, SC (US); LAURA A. MURDOCK, CHARLOTTE, NC (US); KRIS LIKIT-ANURAK, COLUMBIA, SC (US); BRIAN C. BENICEWICZ, COLUMBIA, SC (US)

(21) Appl. No.: 18/023,070

(22) PCT Filed: Sep. 2, 2021
(86) PCT No.: PCT/US2021/048782

§ 371 Date: Feb. 24, 2023

Related U.S. Application Data
(60) Provisional application No. 63/073,536, filed on Sep. 2, 2020.

(51) Int. Cl. C25B 13/08; C25B 1/26; C25B 1/24

(52) U.S. Cl. CPC C25B 13/08; C25B 1/26; C25B 1/24

(57) ABSTRACT

Described herein are proton exchange membrane style electrolyzers, and methods of making same, with a polybenzimidazole (PBI) or sulfonated polybenzimidazole (s-PBI) membrane and metal catalysts on the anode and cathode, which enables both acid independent membrane resistance and lower membrane resistance with higher operating temperatures.

### CROSS REFERENCE TO RELATED APPLICATION

This application is the U.S. National Stage entry of International Patent Application No. PCT/US2021/048782 having a filing date of Sep. 2, 2021, which claims filing benefit of U.S. Provisional Patent Application Ser. No. 63/073,536 having a filing date of Sep. 2, 2020, which is incorporated herein by reference for all purposes.

### TECHNICAL FIELD

The subject matter disclosed herein is generally directed to proton exchange membrane style electrolyzers, and methods of making same, with a polybenzimidazole (PBI) or sulfonated polybenzimidazole (s-PBI) membrane and metal catalysts on the anode and cathode, which enables both acid independent membrane resistance and lower membrane resistance with higher operating temperatures.

### BACKGROUND

Currently, when a chemical plant produces some form of hydrogen halide, this byproduct must be either treated on-site or stored in fifty-five gallon drums and taken off-site to be treated. It would be better both environmentally and financially if these byproducts could be remediated and reused.

Accordingly, it is an object of the present disclosure to a proton exchange membrane style electrolyzer with a sulfonated polybenzimidazole (s-PBI) or polybenzimidazole (PBI) membrane and metal catalysts on the anode and cathode. Using this membrane enables acid independent membrane resistance of ˜0.05 ohm-cm² while Nafion™ exhibits an exponential increase in membrane resistance with increasing acid concentration. Further, PBI and s-PBI membranes do not require external hydration to remain conductive, so this PEM-style electrolyzer can be operated in completely dry conditions, resulting in completely dry product gas streams.

Citation or identification of any document in this application is not an admission that such a document is available as prior art to the present disclosure.

### SUMMARY

The above objectives are accomplished according to the present disclosure by providing in one embodiment, a proton exchange membrane style electrolyzer. The electrolyzer may include at least one polybenzimidazole or sulfonated polybenzimidazole membrane, at least one anode having metal catalysts comprising Ruthenium and Iridium and at least one cathode having metal catalysts comprising Platinum, and the membrane includes acid independent membrane resistance of substantially 0.05 ohm-cm². Further, the polybenzimidazole or sulfonated polybenzimidazole membrane may not require external hydration to remain conductive. Still, the proton exchange membrane style electrolyzer may operate in substantially dry conditions. Yet again, the proton exchange membrane style electrolyzer may produce at least one completely dry product gas stream. Moreover, at least one anhydrous acid gas may be fed to the at least one anode. Still yet, at least one inert gas may be fed to the at least one cathode. Further still, all cathode inlets may be capped. Further yet, the at least one anode may produce a corresponding halide gas to the anhydrous acid provided. Furthermore, the at least one cathode may produce hydrogen gas. Yet again, the at least one cathode may produce water and hydrogen gas when oxygen is fed to the at least one cathode.

In a further embodiment, a method for forming a proton exchange membrane style electrolyzer is provided. The method may include forming at least one polybenzimidazole or sulfonated polybenzimidazole membrane, forming at least one anode having metal catalysts comprising Ruthenium and Iridium and at least one cathode having metal catalysts comprising Platinum, and forming the membrane to have acid independent membrane resistance of substantially 0.05 ohm-cm². Still, the polybenzimidazole or sulfonated polybenzimidazole membrane may be formed to not require external hydration to remain conductive. Further, the proton exchange membrane style electrolyzer may be formed to operate in substantially dry conditions. Still further, the proton exchange membrane style electrolyzer may be formed to produce at least one completely dry product gas stream. Again, at least one anhydrous acid gas may be fed to the at least one anode. Still again, at least one inert gas may be fed to the at least one cathode. Further still, all cathode inlets may be capped. Yet further, the at least one anode may produce a corresponding halide gas to the anhydrous acid provided. Moreover, the at least one cathode may produce hydrogen gas. Furthermore, the polybenzimidazole membrane may be formed via a synthesis route as shown below:

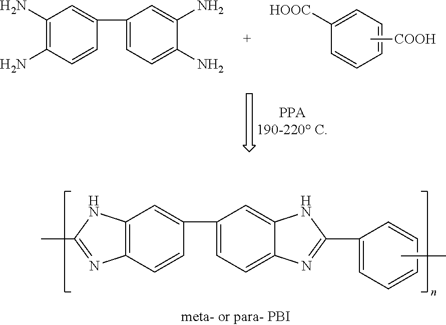

These and other aspects, objects, features, and advantages of the example embodiments will become apparent to those having ordinary skill in the art upon consideration of the following detailed description of example embodiments.

### BRIEF DESCRIPTION OF THE DRAWINGS

An understanding of the features and advantages of the present disclosure will be obtained by reference to the following detailed description that sets forth illustrative embodiments, in which the principles of the disclosure may be utilized, and the accompanying drawings of which:

FIG. 1 shows a graphical plot of electrolysis of liquid-phase HCL via the Uhde process.

FIG. 2 shows a graphical plot of the current disclosure process.

FIG. 3 shows one embodiment of an experimental setup of the current disclosure.

FIG. 4 shows effect on HCL concentration at 1 M, 3.5 M, 7 M and 9 M concentrations.

FIG. 5 shows effects on catalyst at varying HCL concentrations.

FIG. 6 shows one embodiment of a cell assembly of the present disclosure.

FIG. 7 shows an experimental electrolyzer setup of the present disclosure.

FIG. 8 shows cell performance via polarization curve and membrane resistance plots.

FIG. 9 shows a picture of a membrane of the current disclosure.

FIG. 10 shows Table 1.

FIG. 11 shows the effect of current density on a membrane of the current disclosure with constant flow rate, temperature and catalyst.

FIG. 12 shows the effects of temperature and flow rate on a membrane of the current disclosure.

FIG. 13 shows the effects of cathode catalyst and flow rate on a membrane of the current disclosure.

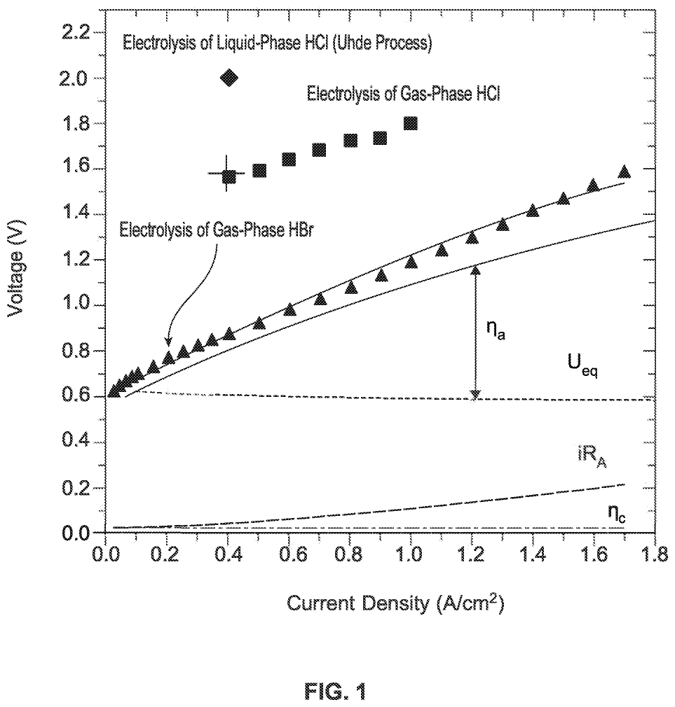

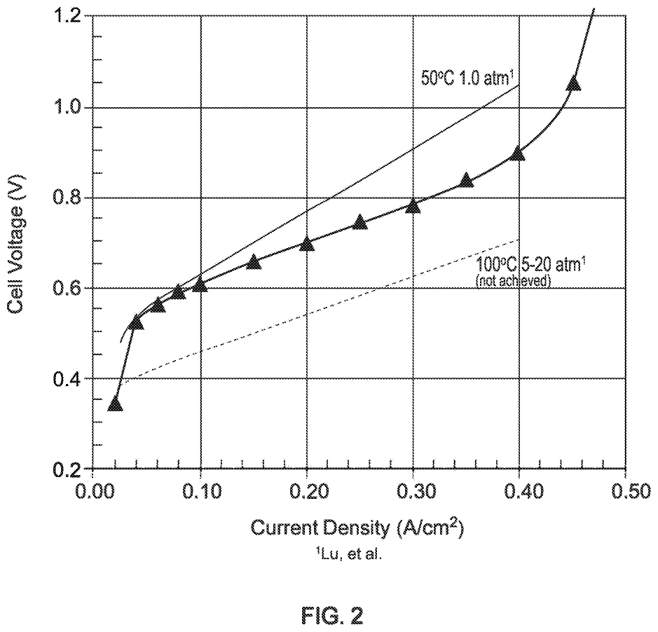

The figures herein are for illustrative purposes only and are not necessarily drawn to scale.

### DETAILED DESCRIPTION OF A PREFERRED EMBODIMENT

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant application should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Where a range is expressed, a further embodiment includes from the one particular value and/or to the other particular value. The recitation of numerical ranges by endpoints includes all numbers and fractions subsumed within the respective ranges, as well as the recited endpoints. Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the singular forms “a”, “an”, and “the” include both singular and plural referents unless the context clearly dictates otherwise.

As used herein, “about,” “approximately,” “substantially,” and the like, when used in connection with a measurable variable such as a parameter, an amount, a temporal duration, and the like, are meant to encompass variations of and from the specified value including those within experimental error (which can be determined by e.g. given data set, art accepted standard, and/or with e.g. a given confidence interval (e.g. 90%, 95%, or more confidence interval from the mean), such as variations of +/−10% or less, +/−5% or less, +/−1% or less, and +/−0.1% or less of and from the specified value, insofar such variations are appropriate to perform in the disclosure. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

The term “optional” or “optionally” means that the subsequent described event, circumstance or substituent may or may not occur, and that the description includes instances where the event or circumstance occurs and instances where it does not.

As used herein, “tangible medium of expression” refers to a medium that is physically tangible or accessible and is not a mere abstract thought or an unrecorded spoken word. “Tangible medium of expression” includes, but is not limited to, words on a cellulosic or plastic material, or data stored in a suitable computer readable memory form. The data can be stored on a unit device, such as a flash memory or CD-ROM or on a server that can be accessed by a user via, e.g. a web interface.

As used herein, the terms “weight percent,” “wt %,” and “wt. %,” which can be used interchangeably, indicate the percent by weight of a given component based on the total weight of a composition of which it is a component, unless otherwise specified. That is, unless otherwise specified, all wt % values are based on the total weight of the composition. It should be understood that the sum of wt % values for all components in a disclosed composition or formulation are equal to 100. Alternatively, if the wt % value is based on the total weight of a subset of components in a composition, it should be understood that the sum of wt % values the specified components in the disclosed composition or formulation are equal to 100.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present disclosure. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure. For example, in the appended claims, any of the claimed embodiments can be used in any combination.

All patents, patent applications, published applications, and publications, databases, websites and other published materials cited herein are hereby incorporated by reference to the same extent as though each individual publication, published patent document, or patent application was specifically and individually indicated as being incorporated by reference.

### Kits

Any of the electrolyzers or methods for forming same described herein can be presented as a combination kit. As used herein, the terms “combination kit” or “kit of parts” refers to the compounds, compositions, formulations, electrolyzers, any additional components that are used to package, sell, market, deliver, and/or provide the combination of elements or a single element of the disclosure. Such additional components include, but are not limited to, packaging, membranes, and the like. When one or more of the compounds, compositions, methods, cells, described herein or a combination thereof contained in the kit are provided simultaneously, the combination kit can contain the components in a single package, such as a proton exchange membrane style electrolyzer. When the compounds, compositions, particles, and electrolyzers described herein or a combination thereof and/or kit components are not provided simultaneously, the combination kit can contain each component in separate combinations. The separate kit components can be contained in a single package or in separate packages within the kit.

In some embodiments, the combination kit also includes instructions printed on or otherwise contained in a tangible medium of expression. The instructions can provide information regarding the content of the exchange membrane style electrolyzer, safety information regarding same, information regarding the electrolyzer, indications for use, and/or instructions for creating same. In some embodiments, the instructions can provide directions and protocols for providing the electrolyzer and methods for making same described herein.

The current disclosure provides a proton exchange membrane style electrolyzer with a polybenzimidazole (PBI) or sulfonated polybenzimidazole (s-PBI) membrane and metal catalysts on the anode and cathode. Using this membrane enables acid independent membrane resistance of ˜0.05 ohm-cm2 while Nafion™ exhibits an exponential increase in membrane resistance with increasing acid concentration. Further, PBI and s-PBI membranes do not require external hydration to remain conductive, so this PEM-style electrolyzer can be operated in completely dry conditions, resulting in completely dry product gas streams.

Anhydrous acid gases are fed to the anode of the electrolyzer. On the cathode, one could feed either an inert gas (nitrogen, argon), air/oxygen (to produce water), or no gas at all (capping the cathode inlet). The product on the anode is the corresponding halide gas (e.g., HCl feed produces Cl₂ gas) and any unreacted hydrogen halide.

The product on the cathode is hydrogen gas when either no gas or an inert gas is fed to the cathode. If air/oxygen is fed, then the product will be water and hydrogen gas. This technology enables the electrochemical remediation of byproduct waste to high-value fuel and feedstocks. Instead of spending money to either treat the waste or have it removed, it can be converted and reused, saving money and decreasing environmental impact. This technology produces high purity and very dry gas products, removing the need for costly separation and drying steps that would normally be required. In addition, the components of the electrolyzer are able to withstand the strong acid conditions, even at high (T<=230 degrees Celsius) operating temperatures.

By using a polybenzimidazole membrane, we eliminate the need for any water in the feed stream to the anode. Further, we can operate at increased temperatures, which will enhance the reaction rate of electrolysis. Because we will operate in the gas phase, essentially all mass transport limitations will be removed, and the electrolyzer will be limited only by the rate of reaction. Finally, because we will not need any water in the feed streams, the products will be of high purity and completely dry, obviating the need for at least some separation and drying steps that would normally be required.

Electrolysis of HCl exhibits promise for large-scale production of hydrogen with the additional benefit of converting a low-value byproduct (HCl) into a more valuable feedstock (Cl₂). However, most of the available publications in literature use aqueous phase HCl as the electrolyte. Previously, gas phase hydrogen bromide (HBr) was shown to electrolyze at current densities an order of magnitude greater than that of aqueous HBr. However, aqueous HBr electrolysis was limited by slow diffusion in the liquid phase.

We show here that gas phase HCl also exhibits higher reactions rates, as reflected by higher current densities, when compared to aqueous phase.

The purpose of this work was to study the efficiency and durability of the anode catalyst (RuO₂ and IrRuO₂), the role of the polymer membrane (Nafion™ vs. polybenzimidazole), and the operating parameters (temperature, HCl flow rate, and current density) in a proton exchange membrane (PEM) electrolyzer. We found that crossing over of chlorine from anode to cathode can poison the catalyst at the cathode, resulting in less durability and shorter lifetime of the electrolyzer. We also discuss how operating temperature, HCl flow rate, and hydration affect the performance of the electrolyzer.

The production of chlorine (Cl₂) is an important aspect as Cl₂ is needed in a variety of industries. Annual Cl₂ production is 65 million tons, energy demand is 317 trillion Btu/year, most Cl₂ is made from brine (NaCl). Cl₂ production methods include cation exchange membrane cells (12%), mercury cells (18%), percolating diaphragm cells (70%). 2018 Elements of the Business of Chemistry, American Chemical Council. Advanced Chlor-Alkali Technology, U.S. DoE, Office of Energy Efficiency and Renewable Energy http://www.essentialchemicalindustry.org/chemicals/chlorine.html

A membrane cell is the cleanest and most energy efficient method wherein Hydrogen Chlorine (HCl) electrolysis produces H₂ and Cl₂ The current disclosure turns the low-value byproduct (HCl) into a more valuable feedstock (Cl₂). Plus, gas phase (e.g., HBr) shows better performance than aqueous phase in electrolysis.

One possible RDE experimental set up includes:
Potential: 0.6V-1.6V (vs. Ag/AgCl)
Disk sweep rate: 50 mV/s
Rotator speed: 400-1600 RPM

One embodiment of an electrolyzer experimental parameter may include:
Cell temperature: 30-180° C.
Cathode flow rate: 100 mL/min N₂
Anode flow rate: 0.1-0.7 L/min HCl(g)
Membrane: Nafion™ 115, 117, 1110, PBI, s-PBI
Catalyst: 3 mg IrRuO₂/cm² (anode), 1 mg Pt/cm² (cathode)

A PBI membrane of the current disclosure may be sulfuric acid and phosphoric acid doped and provides a high temperature membrane capable of function at >150° C. Temperature increases the kinetic rates of the electrolysis reaction. Further, increased acid resistance is provided as well.

One example synthesis route includes:

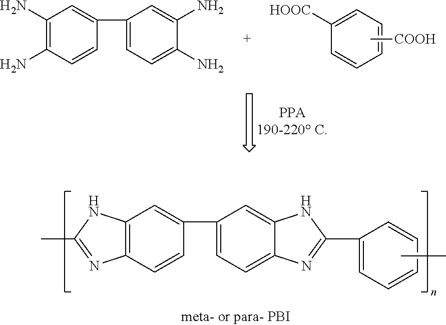

The current disclosure has provided that IrRuOₓ shows better performance than RuO₂ as catalyst for HCl in RDE. The proposed PBI membrane shows promising performance for HCl electrolyzer application as compared to a Nafion™ membrane. Temperature (30-180° C.) exhibits a positive correlation with electrolysis reaction rate (i.e., increased temperature gives increased electrolysis reaction rate), and Pt can be used without issue due to low Cl₂ crossover.

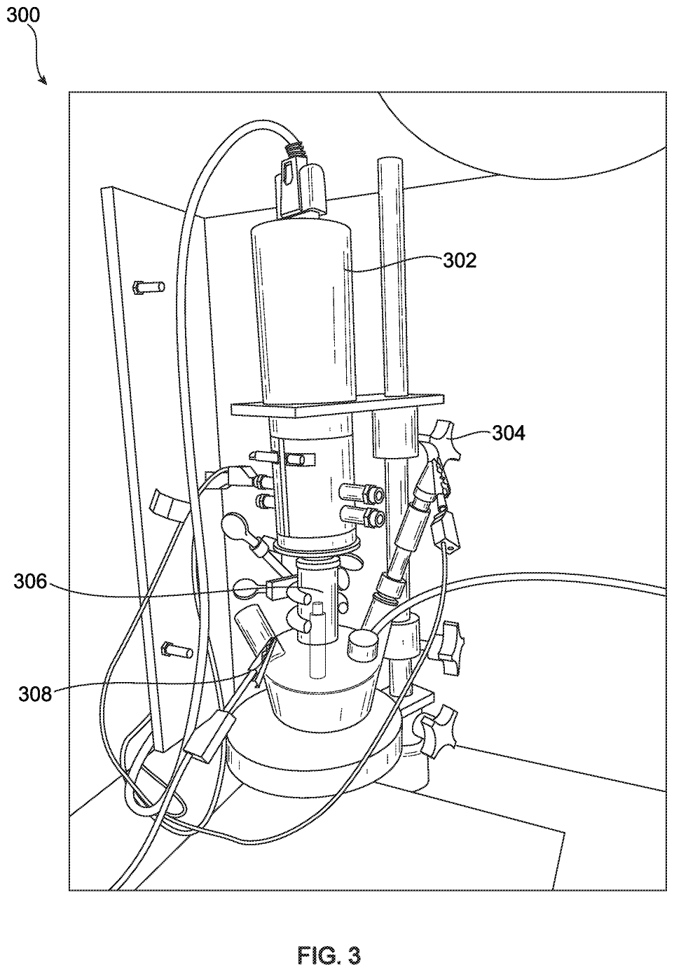

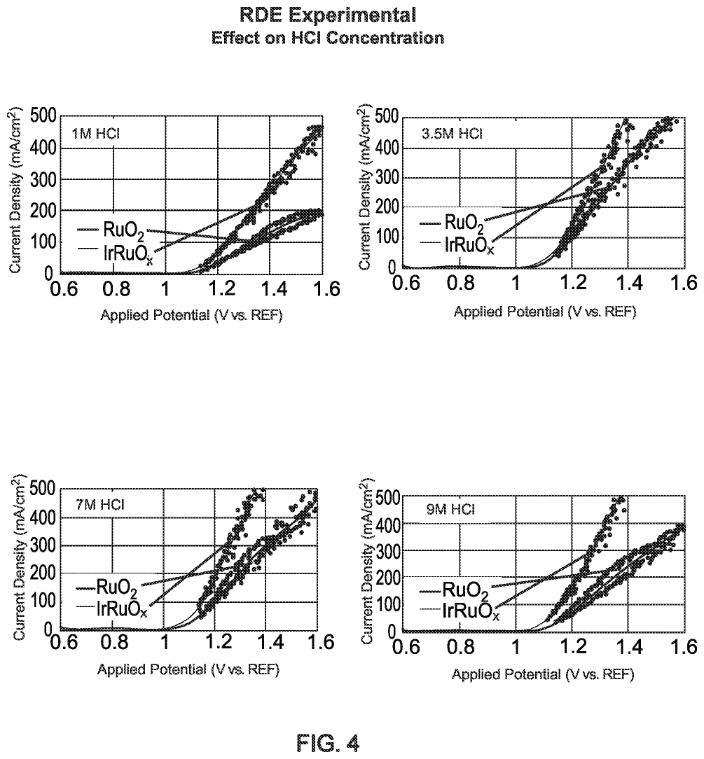

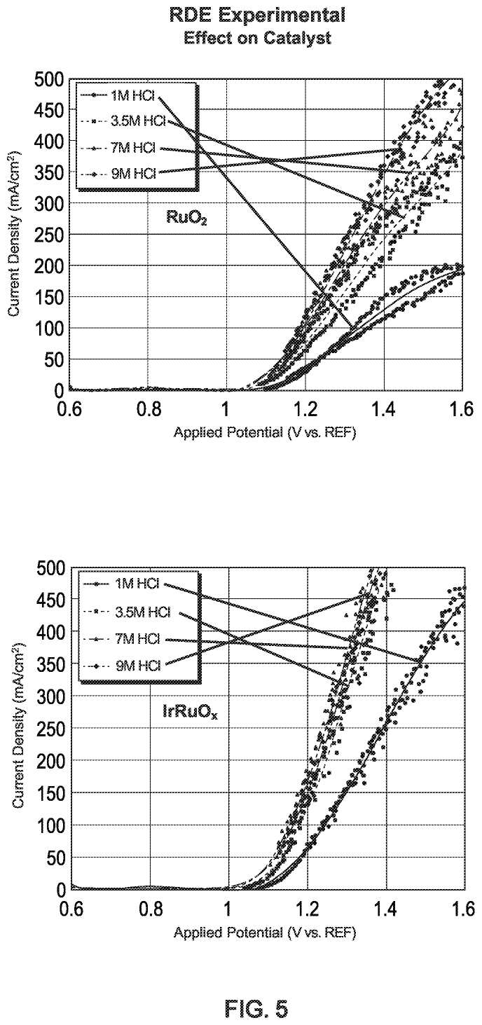

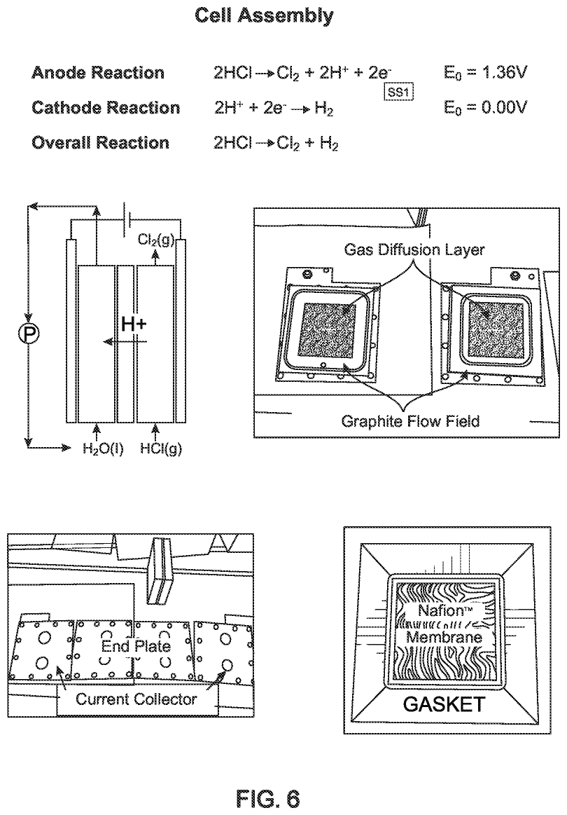

FIG. 3 shows one embodiment of an experimental setup 300 of the current disclosure. Experimental setup 300 may include rotator 302, reference electrode 304, rotating disc electrode 306, and counter electrode 308.

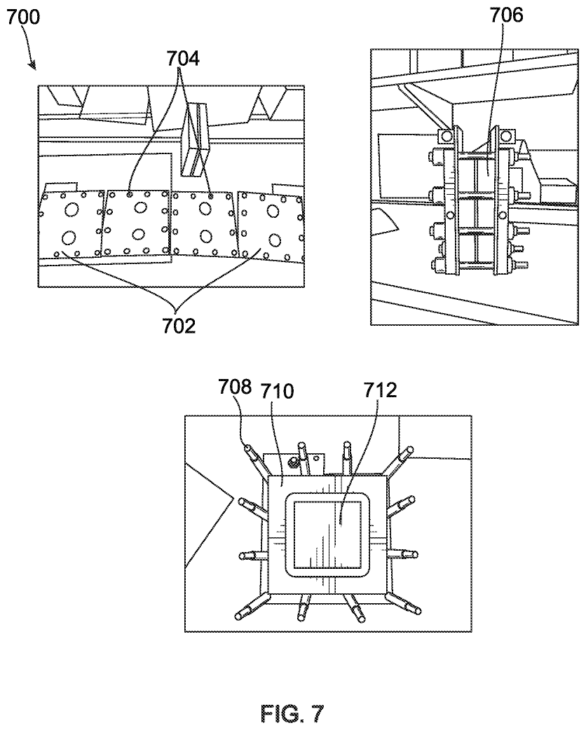

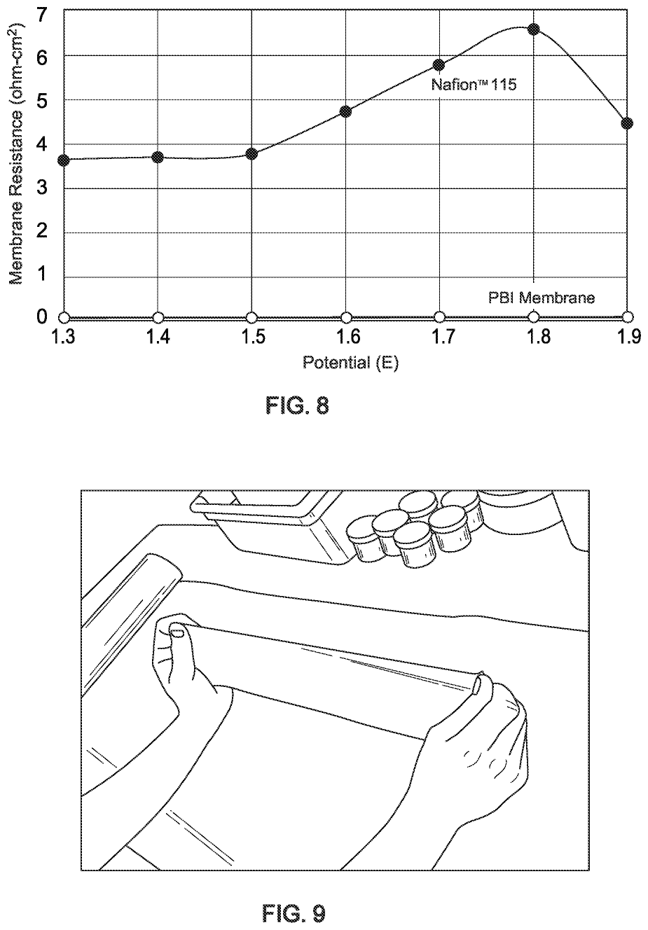

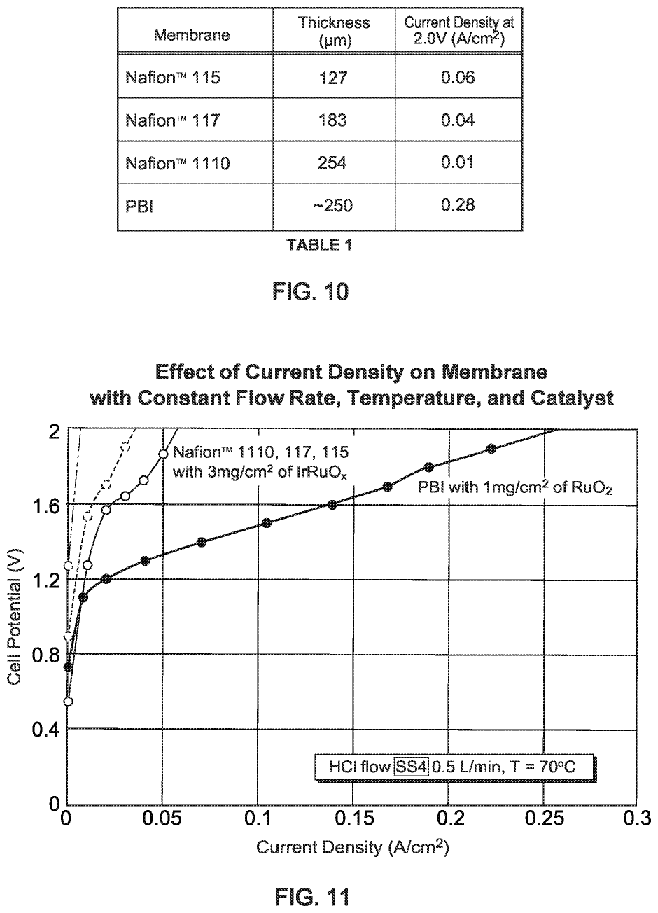

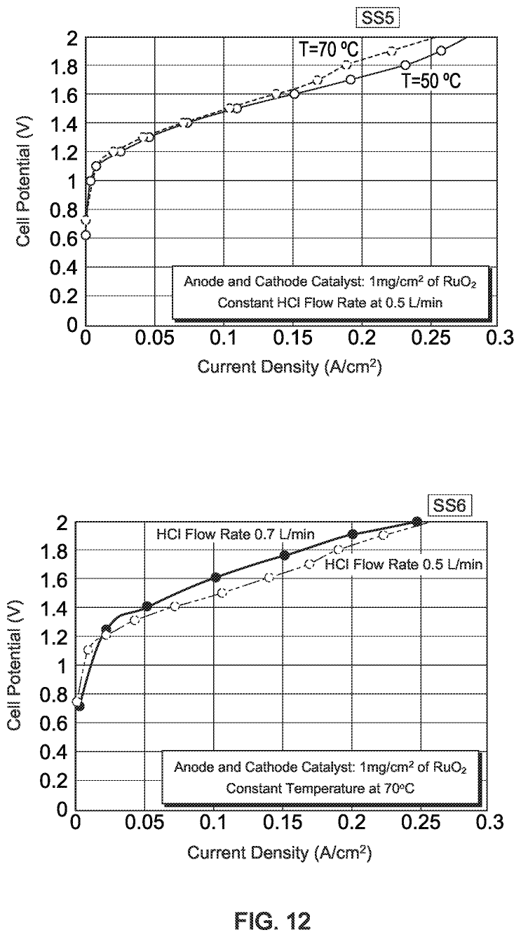

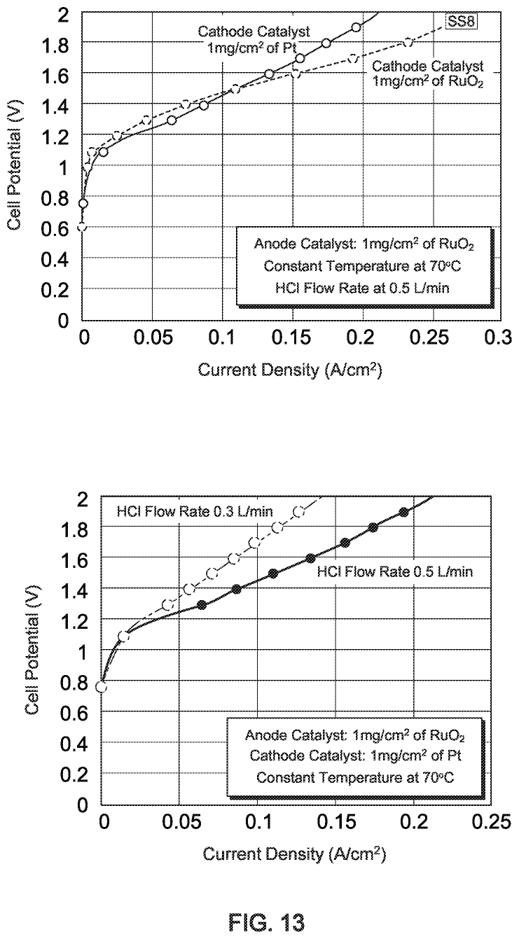

FIG. 7 shows an experimental electrolyzer setup 700 of the present disclosure. Electroylyzer setup 700 may include current collectors 702, electrolyzer frame 704, carbon flow field block 706, tightening bolts 708, inert polymer gasket 710, and membrane electrode assembly 712.

Various modifications and variations of the described methods, pharmaceutical compositions, and kits of the disclosure will be apparent to those skilled in the art without departing from the scope and spirit of the disclosure. Although the disclosure has been described in connection with specific embodiments, it will be understood that it is capable of further modifications and that the disclosure as claimed should not be unduly limited to such specific embodiments. Indeed, various modifications of the described modes for carrying out the disclosure that are obvious to those skilled in the art are intended to be within the scope of the disclosure. This application is intended to cover any variations, uses, or adaptations of the disclosure following, in general, the principles of the disclosure and including such departures from the present disclosure come within known customary practice within the art to which the disclosure pertains and may be applied to the essential features herein before set forth.

1. A proton exchange membrane style electrolyzer comprising:
a membrane, wherein the membrane comprises a polybenzimidazole membrane or a sulfonated polybenzimidazole membrane, the membrane exhibiting an acid independent membrane resistance of substantially 0.05 ohm-cm²;
an anode on a first side of the membrane, the anode comprising a first metal catalyst, the first metal catalyst comprising ruthenium and iridium; and
a cathode on a second side of the membrane, the cathode comprising a second metal catalyst, the second metal catalyst comprising platinum.

2. The proton exchange membrane style electrolyzer of claim 1, wherein the membrane remains conductive in substantially dry conditions.

3. The proton exchange membrane style electrolyzer of claim 2, wherein the proton exchange membrane style electrolyzer is configured to operates in substantially dry conditions.

4. The proton exchange membrane style electrolyzer of claim 2, wherein the proton exchange membrane style electrolyzer is configured to produces at least one anhydrous product gas stream.

5. The proton exchange membrane style electrolyzer of claim 1, further comprising a first gas feed configured to supply an anhydrous gas to the anode.

6. The proton exchange membrane style electrolyzer of claim 1, further comprising gas feed configured to supply an inert gas, air, or oxygen to the cathode.

7. The proton exchange membrane style electrolyzer of claim 1, wherein the cathode comprises a capped inlet.

8-9. (canceled)

10. The proton exchange membrane style electrolyzer of claim 1, wherein the cathode is configured to deliver water and hydrogen produced at the cathode.

11. A method for forming a proton exchange membrane style electrolyzer comprising
locating a membrane between an anode and a cathode, the membrane comprising a polybenzimidazole membrane or sulfonated polybenzimidazole membrane, the membrane exhibiting an acid independent membrane resistance of substantially 0.05 ohm-cm², wherein the anode comprises a first metal catalyst, the first metal catalyst comprising ruthenium and iridium, and the cathode comprises a second metal catalyst, the second metal catalyst comprising platinum.

12-19. (canceled)

20. The method of claim 11, further comprising forming the polybenzimidazole membrane via a synthesis route as shown below:

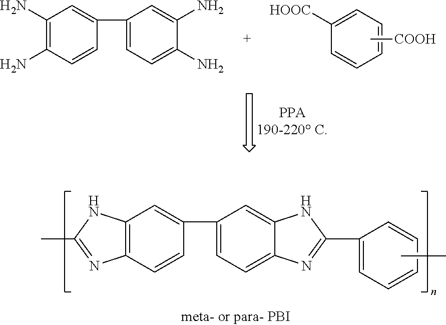

21. A method for electrolyzing a hydrogen halide gas comprising:
feeding the hydrogen halide gas to an anode side of an electrolyzer, the anode comprising a first metal catalyst, the first metal catalyst comprising ruthenium and iridium;
collecting a product halide gas from the anode side of the electrolyzer; and
collecting a product hydrogen gas from a cathode side of the electrolyzer, the cathode comprising a second metal catalyst, the second metal catalyst comprising platinum; wherein
the electrolyzer comprises a membrane between the anode and the cathode, the membrane comprising a polybenzimidazole membrane or a sulfonated polybenzimidazole membrane, the membrane exhibiting an acid independent membrane resistance of substantially 0.05 ohm-cm².

22. The method of claim 21, wherein the method is carried out in substantially dry conditions.

23. The method of claim 21, wherein the hydrogen halide gas comprises hydrogen chloride.

24. The method of claim 21, wherein the hydrogen halide gas comprises hydrogen bromide.

25. The method of claim 21, further comprising feeding an inert gas, air, or oxygen to the cathode.

26. The method of claim 25, wherein air or oxygen is fed to the cathode, the method further comprising collecting water produced at the cathode.

27. The proton exchange membrane style electrolyzer of claim 1, wherein the first metal catalyst comprises RuO₂.

28. The proton exchange membrane style electrolyzer of claim 1, wherein the first metal catalyst comprises IrRuO₂.

29. The proton exchange membrane style electrolyzer of claim 1, the membrane comprising sulfuric acid.

30. The proton exchange membrane style electrolyzer of claim 1, the membrane comprising phosphoric acid.
